(19) United States
(12) Patent Application Publication
(10) Pub. No.: US 2007/0298172 A1
(43) Pub. Date: Dec. 27, 2007

(54) TILE AND SUBSTRATE BONDING SYSTEM

(76) Inventor: William M. Carty, Alfred Station, NY (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/423,315

(22) Filed: Jun. 9, 2006

(51) Int. Cl. B32B 9/00; B32B 13/00; B05D 1/40; C03B 29/00

(52) U.S. Cl. 427/331; 428/701; 428/702; 428/703; 156/89.11

(57) ABSTRACT

A method for increasing the strength of the bond between a cementitious layer and a tile or substrate layer, including applying a coating of high-silica glaze to the tile, bonding the high-silica glaze to the tile, bonding the high-silica glaze to the cementious layer, and curing the cementitious layer to yield a high-strength bonded tile system. The high-silica glaze further includes silica and flux. The molar ratio of silica to flux is at least about 5 to 1 and the flux further comprises RO and R₂O. The molar ratio of RO to R₂O is at least about 7 to 3. RO is selected from the group including CaO, SrO, BaO, ZnO, FeO, PbO and their combinations and R₂O is selected from the group including Li₂O, Na₂O, K₂O, and their combinations.

### CROSS-REFERENCE TO RELATED APPLICATION

The present application is a utility application claiming priority to, and based upon, co-pending U.S. patent application Ser. No. 11/419,617 filed May 22, 2006, which claimed priority to then co-pending U.S. patent application Ser. No. 11/191,107, filed Jul. 27, 2005 and issued on May 23, 2006 as U.S. Pat. No. 7,048,795.

### TECHNICAL FIELD OF THE INVENTION

The present invention relates generally to the field of ceramic compositions, and, more specifically, to the bonding of cementitious materials to porcelain bodies.

### BACKGROUND OF THE INVENTION

It is widely accepted that the strength of conventional concrete is strongly coupled to the strength of the aggregate material included therein. Ultimately, the strength of conventional concrete is limited by the strength of the aggregate, so opportunities to enhance the strength of concrete are rooted in the development of high-strength aggregate. Recent progress in aggregate development, hinging in part on the development of shaped aggregate, indicates that high-strength porcelain offers a unique opportunity for the development of high-strength concrete. However, as shown in FIGS. 1 and 2, preliminary testing of concretes including a dispersed high-strength porcelain aggregate phase in a Portland cement matrix indicated that the fracture path strongly favored the interface between the aggregate and the cement paste, signaling that better bonding of the cement paste to the aggregate would assist in the efficient transfer of the aggregate strength to the concrete composite.

Likewise, there are also needs for improving the bonding of conventional aggregate to cement paste. The variability of mineralogy of conventional aggregate, and thus significant differences in the surface chemistry, results in varied and uncontrolled surface reactions with cement paste and thus yields variability in aggregate-cement paste bonding. The problems with conventional aggregate give rise to a need for a room temperature or low temperature surface coating that will strongly bond to a variety of mineral surfaces and promote a strong bond to cement paste.

Further, other ceramic bodies that are secured by mortar or cement, such as tile bodies, could likewise benefit from bonding improvements. For example, the adherence of ceramic and porcelain tile to thin-set mortars, modified thin-set mortars and typical hydraulic cement bonding systems (Portland cement (calcium silicate) and other cement systems, such as calcium aluminates (commonly referred to as refractory cements) and calcium phosphates) is typically uneven and could be improved upon. Adherence improvements would thus be beneficial for dense ceramic systems, such as porcelain and stoneware tiles and other dense ceramic tiles (such as dense earthenware tiles, tiles produced from waste glass, glass tiles, etc.).

Thus, to better utilize porcelain as concrete aggregate, there remains a need for providing a better bond between the porcelain aggregate material and the cementitious matrix. The present invention addresses this need.

### SUMMARY OF THE INVENTION

The present invention relates to improving the bonding of mortars and/or cements to a whiteware or porcelain body through the use of a highly siliceous intermediary matte glaze to improve the bonding of the body to the mortar/cement paste. One object of the present invention is to provide an improved cementitious bond. Related objects and advantages of the present invention will be apparent from the following description.

### BRIEF DESCRIPTION OF THE DRAWINGS

FIG. 1. is a photomicrograph of a first fracture surface in a concrete having a porcelain aggregate phase dispersed in a Portland cement matrix, wherein the fracture surface favors the aggregate-matrix interface.

FIG. 2. is a photomicrograph of a second fracture surface in a concrete having a porcelain aggregate phase dispersed in a Portland cement matrix, wherein the fracture surface favors the aggregate-matrix interface.

FIG. 3 is a perspective view of a plurality of like-shaped aggregate bodies.

FIG. 4 is a schematic view of a porcelain-high silica glaze-Portland cement bond.

FIG. 5 is a SEM photomicrograph of the bond of FIG. 4.

FIG. 6 is a perspective view of a concrete body having porcelain aggregate pieces bonded into a Portland cement matrix via a high-silica intermediary bonding layer.

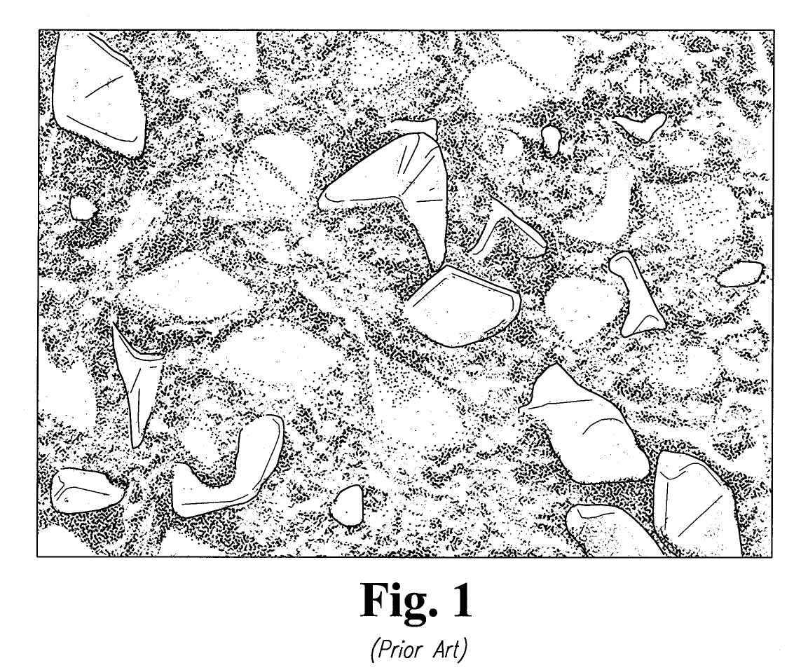

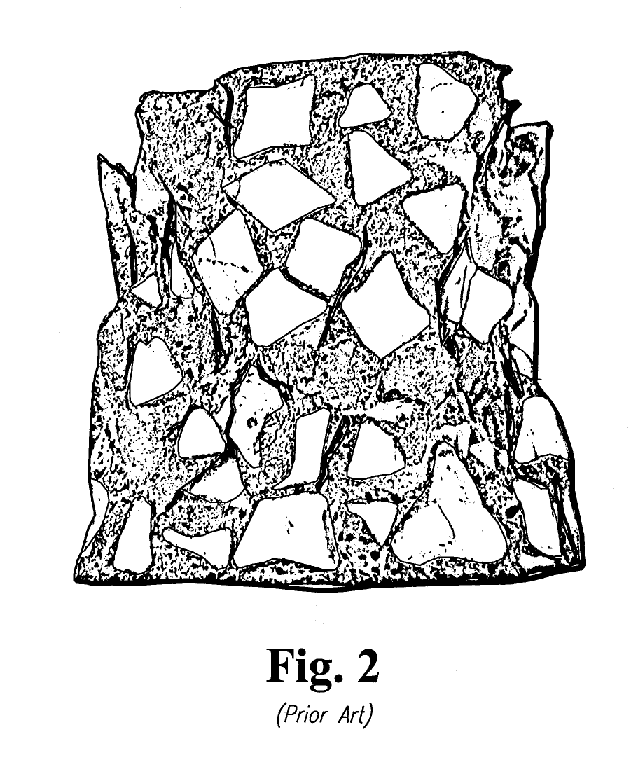

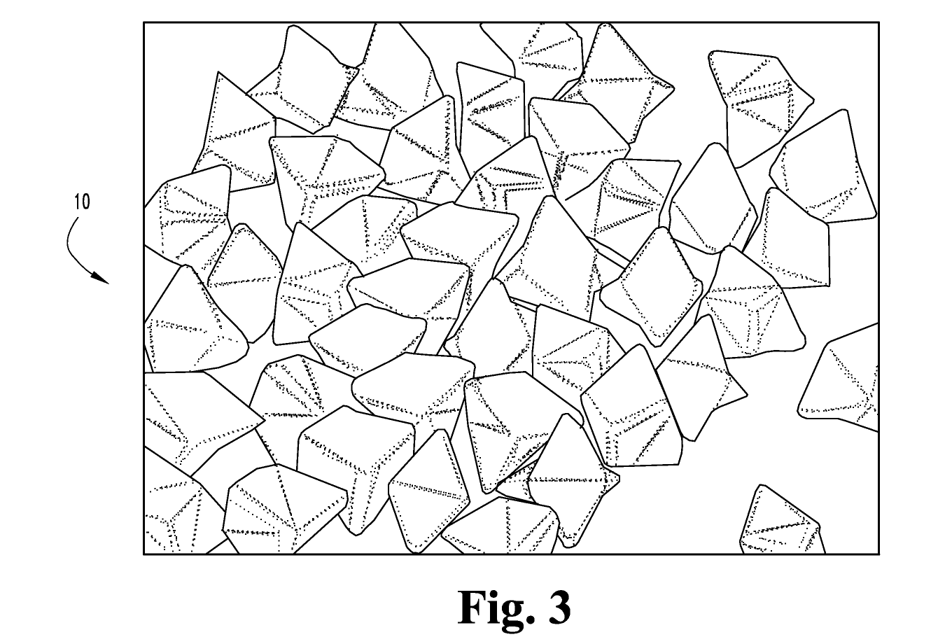

### DETAILED DESCRIPTION OF THE PREFERRED EMBODIMENTS

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

The present invention relates to concretes enjoying a glaze-assisted cement-aggregate bond with increased strength, and a method for making the same. In particular, the method is useful for increasing the strength of the bond between the cementitious matrix and the dispersed porcelain aggregate phase therein; the invention is particularly useful in enhancing the bond between a Portland cement matrix and a dispersed shaped porcelain aggregate phase to thus enhance the strength of the concrete.

### Overview

Ceramic glazes offer an opportunity to establish a microscopically roughened surface that may enhance mechanical bonding. Further, through careful control of the chemistry of the glaze, chemical bonding of the cement paste to the high-strength aggregate may be promoted. A strong chemical-mechanical bond offers the most efficient route for transferring the mechanical strength attributes of the aggregate to the concrete composite.

To demonstrate the effect of enhancing the bonding between cement paste and porcelain aggregate via the use of a glaze on the porcelain aggregate, a series of test glazes were developed that systematically altered the surface texture and chemistry of the glazed aggregate. It was demonstrated that gloss glazes provided the smoothest surface for enhanced mechanical bonding and thus bonded the least well to the cement matrix. Matte glazes that were high in alumina and low in silica bonded only slightly better to the cement matrix; but matte glazes high in calcium and silica (and therefore low in alumina and alkali) bonded strongly to the cement matrix. These high calcium-high silica glazes typically exhibit a craggy, rough surface providing both high surface area (for chemical interactions) and sufficient roughness to promote mechanical bonding. While data suggests that the contributions from the chemical bonding mechanism dominate those of the mechanical bonding mechanism, it is clear that the combination of chemical and mechanical enhances the bond between the cementitious matrix and the porcelain aggregate phase, greatly increasing the strength of the concrete.

By enhancing the bonding between the cement matrix and the high-strength aggregate, the strength of the concrete is enhanced, thus providing a comparatively inexpensive method for producing high-strength concrete. This approach allows for the bonding of the cement matrix to a high-strength aggregate to be specifically manipulated to allow greater or lesser bonding, thus allowing the properties of the cement to be precisely controlled. In other words, by controlling the cement-aggregate interfacial strength, the strength or toughness of the concrete can be fine-tuned to fit the requirements of a specific application.

While the description and embodiments herein focus on porcelain aggregate dispersed in a Portland cement matrix with a high-silica interfacial glaze layer therebetween, other aggregate compositions coated with glaze layers of other compositions and dispersed in matrices of other compositions are likewise contemplated; the scope of the invention is not necessarily limited to porcelain aggregate dispersed in Portland cement.

### Aggregate Considerations

As seen in FIG. 3, the aggregate typically defines porcelain pieces or bodies 10. The bodies 10 are typically of like size, although they may be of different sizes and may be described by any convenient size distribution curve. The bodies 10 are typically composed of porcelain. A typical porcelain composition is about 36% clay (composed of a mixture of kaolin and ball clay), about 13 weight percent alumina, about 29 weight percent quartz, and about 22 weight percent nepheline syenite; however, the aggregate may be composed of any convenient porcelain composition or range of compositions.

While the aggregate bodies 10 may have any convenient shape(s), the aggregate bodies 10 typically have similar shapes, more typically have substantially the same shape, and still more typically have specific geometric shapes, such as that of the tetrajack. A tetrajack is a three dimensional shape that may be described as a base tetrahedron (the base) with coincident tetrahedra joining its four faces. The tetrajack shape offers the advantage of having one of the highest know packing densities.

While the aggregate bodies 10 may be glaze coated in their green state, sintering or bisque firing the green bodies makes them less fragile and less prone to deformation during handling prior to firing. For example, the green bodies may be heated at a rate of approximately 1.5 degrees Celsius per minute to a temperature of 1260° C. and then allowed to soak or dwell at temperature (1260° C.) for 3 hours. After the soak, the bodies 10 are cooled substantially to room temperature at a rate of 1.5 degrees Celsius per minute. Typically, the bodies 10 are bisque fired to a temperature of at least about 1150 degrees Celsius, and more typically to at least about 1250 degrees Celsius with a soak of at least about 2 hours.

### Aggregate Preparation

The glaze, in either a fritted or raw form, is applied to the aggregate bodies 10 using conventional means (i.e., spraying, dipping, or via a waterfall technique) to provide a thin (typically less than about 200 μm and more typically about 50 μm) coating after firing. Typically, the aggregate is calcined (i.e., low temperature bisqued) prior to glazing to promote a stronger bond between the aggregate and the glaze, although green (unfired) and fully vitrified porcelain can also be glazed using this approach.

A relatively thin glaze coating is typically applied to reduce the tendency of failure occurring within the glaze layer and also to improve the transfer of stress to the aggregate. The glaze is matured by firing at elevated temperature, the level of which is dictated by the maturation temperature of the porcelain body. Typical temperatures range from about 1150° C. to about 1320° C., although other temperatures are possible. Overfiring of the aggregate may impair the strength and may also promote the formation of a glossy surface, thus reducing the effectiveness of the glaze coating as a means of improving the bonding between the cementious matrix phase and the high-strength aggregate phase.

### Composition Considerations

Flux ratio: Analysis of ceramic glazes used by industry and artists indicate that the ratio of alkali oxides and the RO oxides is 0.3:0.7 (R₂O:RO), but can range from 0.2:0.8 to 0.4:0.6 in industrial glazes. Li₂O, Na₂O, and K₂O are collectively referred to as the alkali (i.e., R₂O) oxides, but in most glazes are typically an unspecified blend of Na₂O and K₂O. The RO oxides are typically referred to as the alkaline earth oxides of MgO, CaO, SrO, and BaO, FeO, but also including ZnO and PbO. Trials of these glazes at the 0.3:0.7 level indicates that these glazes typically do not bond strongly to the cement paste, and that bonding occurs most readily when the ratio of R₂O:RO is less than 0.25:0.75; bonding most readily occurs when the ration of R₂O:RO is about 0.1:0.9. Further decreases in the relative amount of alkali (R₂O) typically does not enhance the bonding between the cement phase and the porcelain aggregate phase.

Al₂O₃: Furthermore, the ratio of alumina (Al₂O₃) to the sum of the fluxes (R₂O+RO, on a molar ratio basis is always equivalent to unity, or 1.0) is typically held at the 0.3 level or below, and more typically alumina is present at a level of 0.2 moles to mole of flux. Typical Al₂O₃ levels in industrial glazes range from 0.3 to 0.6 and the specific ratio is usually dictated by the intended industrial application and the glaze esthetic. Increasing the alumina level typically increases the glaze durability in commercial industrial glazes, but in this application, higher alumina levels tend to limit the degree of the chemical bonding of the cement paste to the glaze coating.

SiO₂: A higher silica level in the glaze typically promotes chemical bonding between he glaze and the cement paste. This is believed to be due to the general deficiency of silica in the Portland cement system, and the saturation of the liquid phase in the cement paste with calcium. Cement pastes are saturated with calcium during the reaction phase due to the dissolution (of Portland cement) and the precipitation (of the hydrated cement phase) mechanisms in the cement paste reactions, so the availability of additional silica is beneficial. Having a surface that is high in silica, as is present in the high-silica matte glazes, promotes chemical bonding between the cement paste and the porcelain aggregate. In addition, high silica glazes, particularly those that are low in alkali (R₂O) tend to have strong matte surfaces, and when observed in a scanning electron microscope, the matte character is manifest as a rough, craggy surface (as illustrated in FIG. 3). The molar ratio of SiO₂ to flux (R₂O+RO) is typically at least 5:1 but can be as high as 9:1. If the silica level is too high, the glaze will not react sufficiently with the porcelain aggregate to bond strongly thus limiting the benefits associated with promoting a cement-glaze reaction.

B₂O₃: If B₂O₃ is added to the glaze, the molar ratio to the fluxes should also be low, below 0.3. Excessive boron will soften the glaze and reduce the glaze viscosity at high temperature, but does not enhance bonding between the cement paste and the porcelain aggregate.

Typical compositions: Two typical compositions for a glaze that enhances the bonding between the cement paste and a high-strength porcelain aggregate, represented on a molar ratio basis are

0.1 R₂O, 0.9 CaO; 0.20 Al₂O₃, and 6.0 SiO₂ (Glaze 21A in Table 1) and

0.1 R₂O, 0.9 CaO; 0.20 Al₂O₃, and 7.0 SiO₂ (Glaze 26A in Table 1).

### (When represented on a molar percentage basis, these glazes are composed of 1.39% R₂O, 12.50% RO, 2.78% Al₂O₃, and 83.33% SiO₂ (Glaze 21A) and 1.22% R₂O, 10.98% RO, 2.44% Al₂O₃, and 85.37% SiO₂ (Glaze 26A), respectively.)

Table 1 below lists several high-silica glaze compositions.

TABLE 1

| Glaze | Unity Molecular Formula or Molar Ratio Basis | | | |
|---|---|---|---|---|
| Designation | K₂O + Na₂O | CaO + MgO | SiO₂ | Al₂O₃ |
| 21 | 0.3 | 0.7 | 6.0 | 0.20 |
| 22 | 0.3 | 0.7 | 6.0 | 0.28 |
| 26 | 0.3 | 0.7 | 7.0 | 0.20 |
| 27 | 0.3 | 0.7 | 7.0 | 0.28 |
| 29 | 0.3 | 0.7 | 8.0 | 0.20 |
| 30 | 0.3 | 0.7 | 8.0 | 0.28 |
| 32 | 0.3 | 0.7 | 9.0 | 0.20 |
| 33 | 0.3 | 0.7 | 9.0 | 0.28 |
| 21a | 0.1 | 0.9 | 6.0 | 0.20 |
| 22a | 0.1 | 0.9 | 6.0 | 0.27 |
| 26a | 0.1 | 0.9 | 7.0 | 0.20 |
| 27a | 0.1 | 0.9 | 7.0 | 0.28 |
| 29a | 0.1 | 0.9 | 8.0 | 0.20 |
| 30a | 0.1 | 0.9 | 8.0 | 0.28 |
| 32a | 0.1 | 0.9 | 9.0 | 0.20 |
| 33a | 0.1 | 0.9 | 9.0 | 0.27 |
| 21-1 | 0.3 | 0.7 | 5.33 | 0.20 |
| 21-2 | 0.3 | 0.7 | 5.33 | 0.17 |
| 21-3 | 0.3 | 0.7 | 4.66 | 0.20 |
| 21-4 | 0.3 | 0.7 | 4.66 | 0.16 |
| 21-5 | 0.3 | 0.7 | 4.0 | 0.20 |
| 21-6 | 0.3 | 0.7 | 4.0 | 0.13 |

### Bond Formation

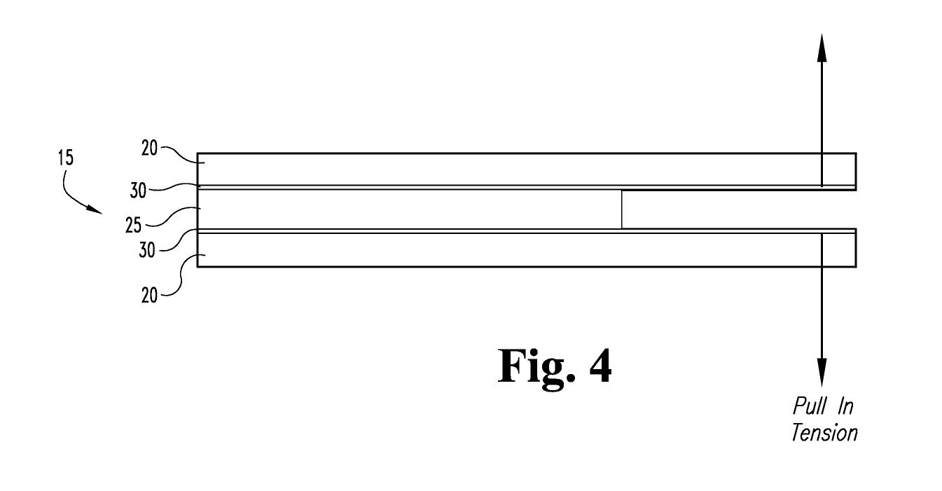

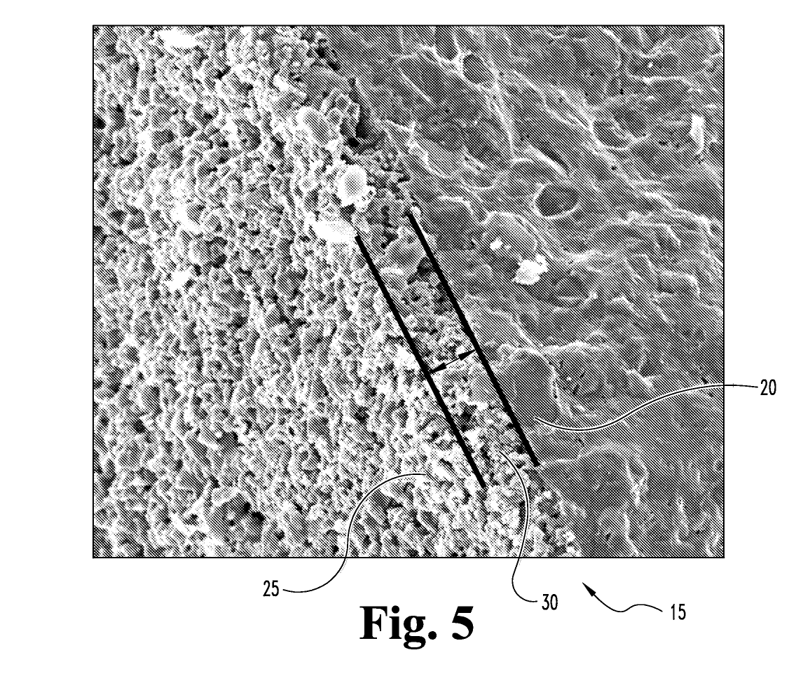

As shown in FIGS. 4 and 5, a high-strength bond 15 is produced between the aggregate material and the cementitious matrix by first identifying a first porcelain surface 20 and a cementitious second surface 25 to be bonded together and then treating the first porcelain surface 20 by glazing a bonding layer 30 thereto. The first porcelain surface 20 is prepared for bonding in the cementitious matrix by firing the first porcelain surface 20 to a temperature of at least about 1150 degrees Celsius to bond the glaze layer 30 thereto. The prepared first porcelain surface 20 and the cementitious second surface 25 are then chemically joined in the bonding layer 30 to produce a bond 15. Typically for porcelain aggregate bonded in a Portland cement matrix, bonding layer 30 is a glaze having the general formula of (0.1 R₂O, 0.9 RO)·6.0 SiO₂, with R₂O typically selected from the group consisting of Li₂O, Na₂O, K₂O, and their combinations and RO typically selected from the group consisting of CaO, SrO, BaO, ZnO, FeO, PbO and their combinations.

### EXAMPLES

### Example 1

Green porcelain aggregate 10 was glazed via dipping. Glaze suspensions of 30, 35, and 40 weight percent solids (with the remained being water) were tested for dipping. Green aggregate was sufficiently wetted by dipping into glaze suspensions to cause a significant portion of the green aggregate bodies 10 to lose their shape. The dipped green aggregate bodies 10 also absorbed sufficient glaze to result in a thick coating sufficient to effectively bring the aggregate closer to spherical shape. The coated green bodies 10 were fired to a soak temperature of about 1150 degrees Celsius and held at temperature for 4 hours.

### Example 2

Green porcelain aggregate was sprayed with aqueous suspensions of 30, 35, and 40 weight percent solid. The aggregate was placed in a strainer and then sprayed. The aggregate were tumbled in the strainer while being sprayed to maximize the homogeneity of the coating. The coated green bodies were fired to a soak temperature of about 1250 degrees Celsius and held at temperature for 2 hours.

### Example 3

Bisqued aggregate was glazed (both by dipping and by spraying) with aqueous suspensions of 35 and 40 weight percent solid with 2, 3 and 4 weight percent additions of polyethylene glycol and/or carboxy methylcellulose (to thicken the glaze for increased adherence to the bisqued aggregate). Dipping quantities of aggregate in glaze resulted in adherence of individual aggregate pieces to one another, which would give rise to the aggregate fusing together during firing. Sprayed aggregate had more uniform and thin glaze coatings and did not adhere to one another. The coated bisqued bodies were fired to a soak temperature of about 1200 degrees Celsius and held at temperature for 3 hours.

### Example 4

Predetermined amounts of aggregate were tumbled with predetermined amounts of glaze suspension (of composition 21-2) such that the glaze was sufficient to coat the aggregate without giving rise to adhesion of aggregate pieces. 6.2 kg of porcelain aggregate was tumbled with 220 grams of 35 weight percent glaze compositions 21-2 (with 2 weight percent CMC thickener) for one minute in a 5 gallon vessel. The glazed aggregate was then removed from the vessel and air dried. The glazed bodies 10 were fired to 1200° C. for 3 hours.

### Firing

Glazes 21-33 and 21a-33a were fired at various temperatures ranging from 1245° C. to 1315° C. The ramp rate in these firings was 300° C. per hour with a hold at peak temperature for 3 hours.

Glaze 21 and glazes 21-1 through 21-6 were fired at various temperatures from 1050° C. to 1250° C. The ramp rate in these firings was approximately 150° C. per hour with a hold at peak temperature for 45 minutes.

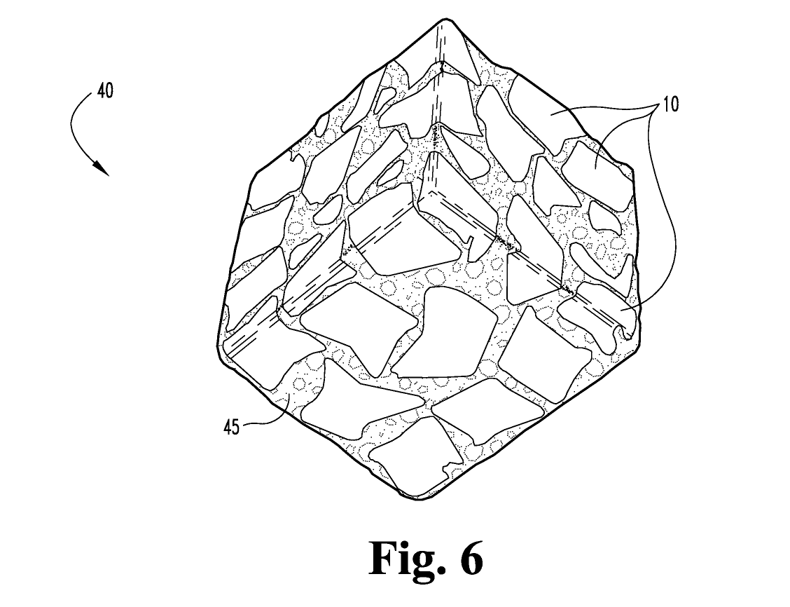

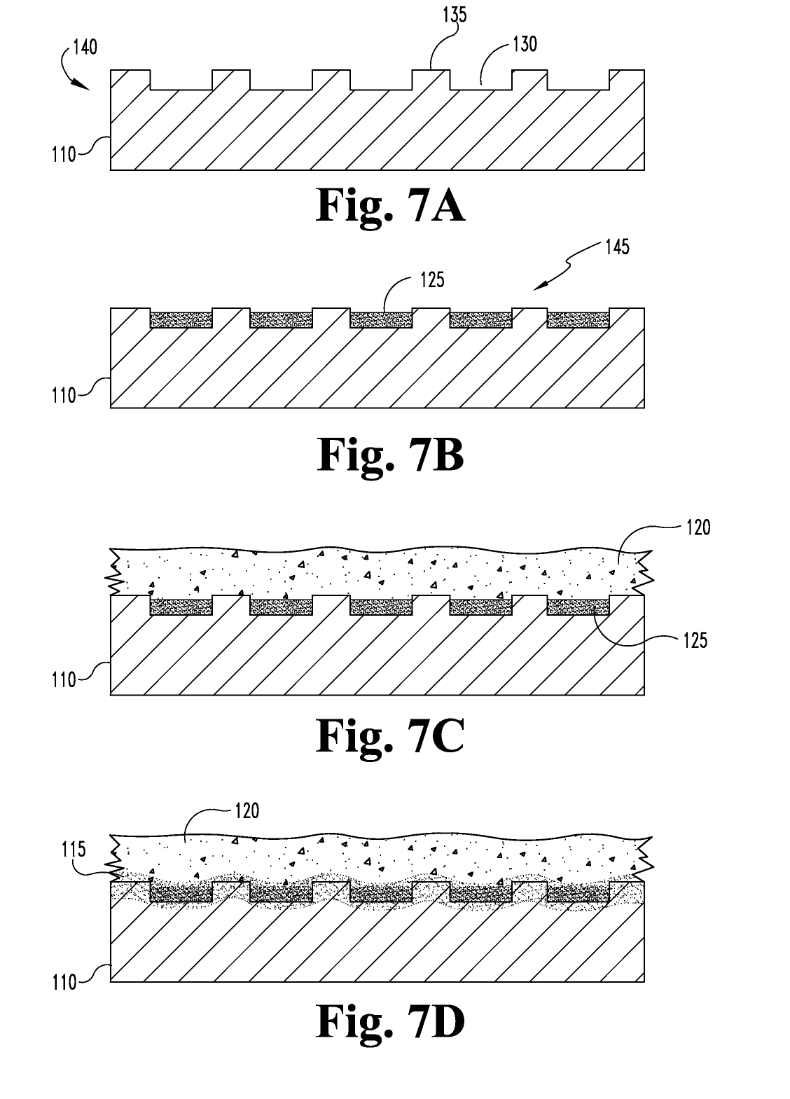

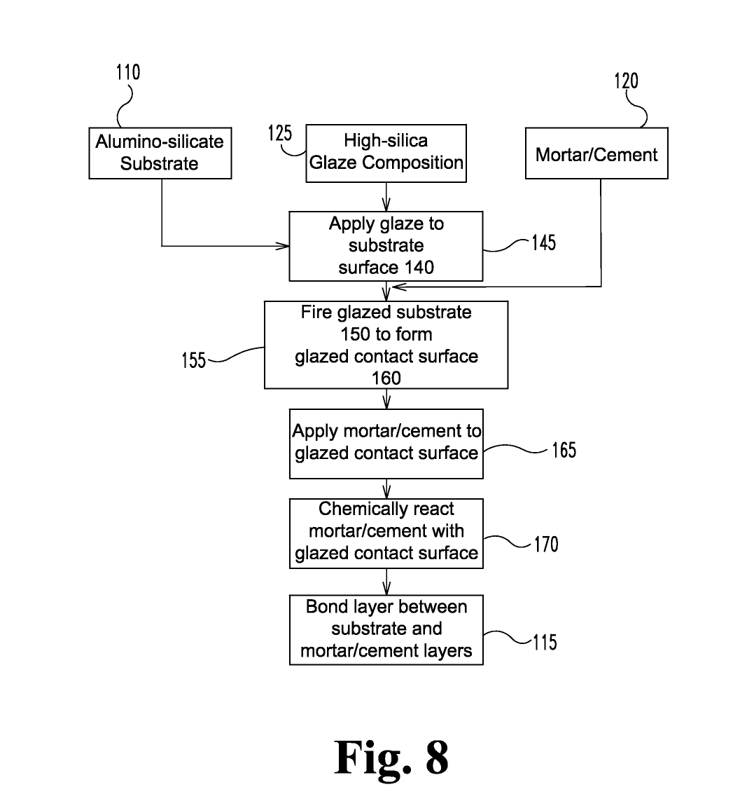

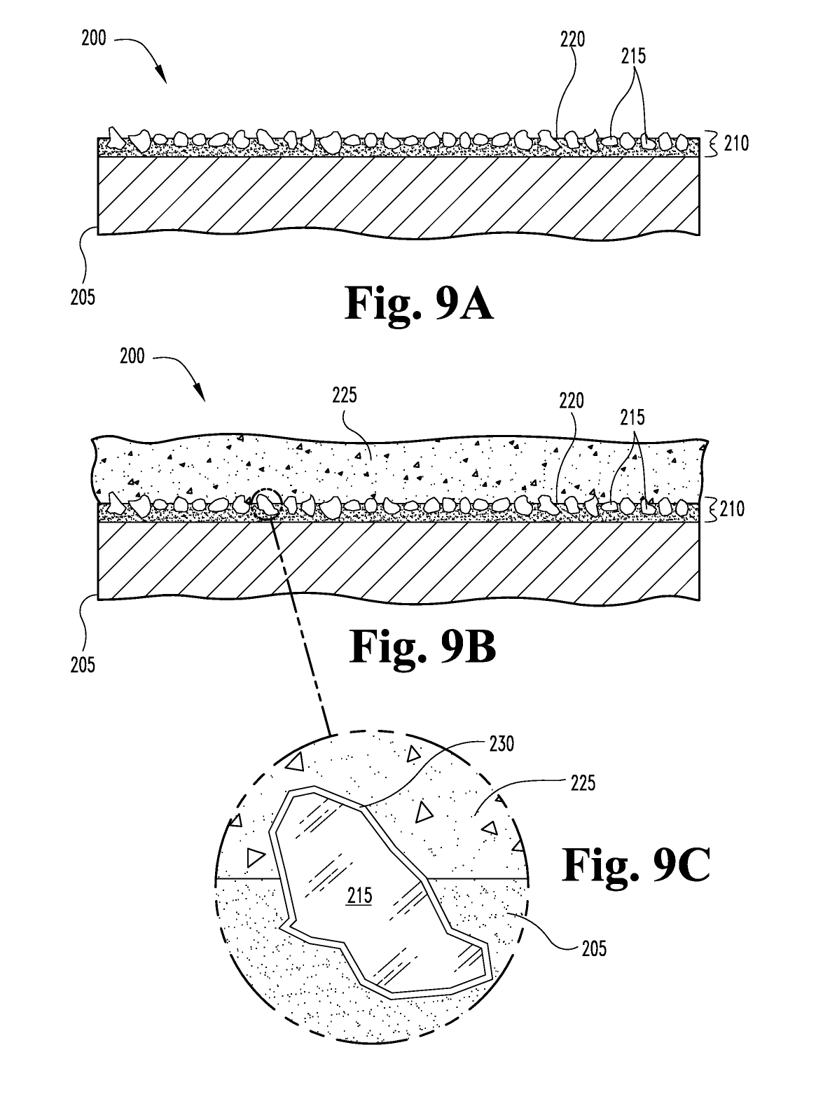

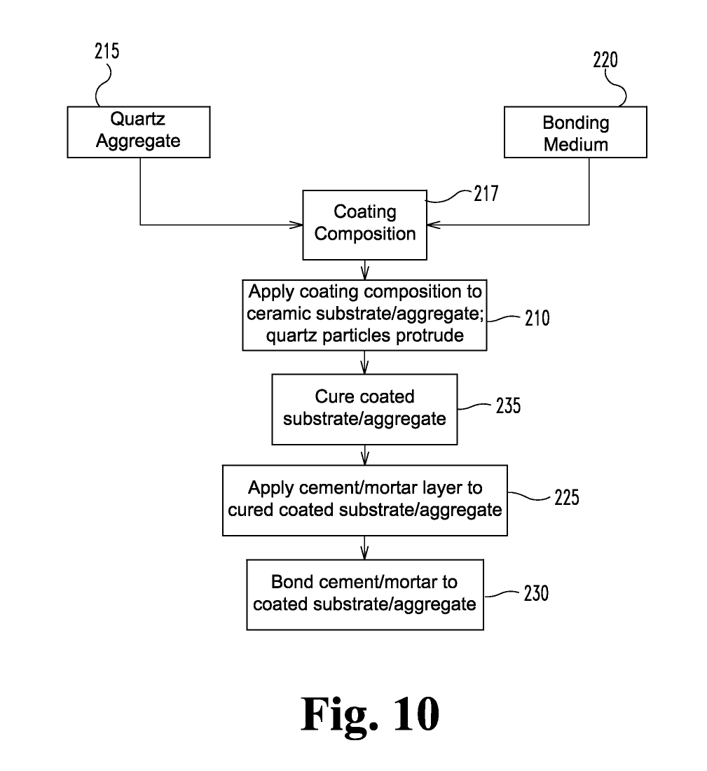

In operation, a high-strength Portland-cement based concrete 40 is produced by first applying a coating of high-silica glaze to (typically porcelain) aggregate pieces 10 and then firing the porcelain aggregate pieces 10 to bond the high-silica glaze layer 30 thereto, typically to a temperature of at least about 1150 degrees Celsius. (See FIG. 6). The glaze-coated porcelain aggregate pieces 10 are dispersed in a Portland cement matrix 45, where the high-silica glaze layer 30 is bonded to the Portland cement matrix 45. Finally, the Portland cement matrix 45 is cured to yield high-strength concrete 40. As noted above, the high-silica glaze layer 30 typically is substantially comprised of silica and flux, with a typical molar ratio of silica to flux of at least about 5 to 1. The flux typically has a composition of RO and R₂O, wherein the molar ratio of RO to R₂O is typically at least about 7 to 3, and is more typically about 9 to 1. RO is typically selected from the group including CaO, SrO, BaO, ZnO, FeO, PbO and their combinations and R₂O is typically selected from the group including Li₂O, Na₂O, K₂O, and their combinations. Alumina may be added to the composition, typically in an amount such that the molar ratio of flux to alumina is about 5:1.

Typically, the aggregate pieces 10 are all substantially the same size; however, the aggregate pieces 10 may be characterized by any convenient size distribution curve. More typically, the aggregate pieces 10 all have the same or similar shapes, and more typically the aggregate pieces 10 have the shape of a tetrajack.

FIGS. 7A-8 relate to another embodiment of the present invention, a bonding system 100 wherein a porcelain, stoneware or like sintered tile substrate 110 forms an enhanced bond 115 with a mortar or cement material 120 via an intermediate low-alumina/high silica glaze layer 125 applied to the substrate 110. Typically, the bond 115 is characterized as having less than about 0.25 molar equivalents of alumina. As noted previously, higher alumina levels promote chemical durability and thus inhibit surface bonding reactions with mortar or cement paste; the above discussion relating to substrate compositional ranges and glaze compositional ranges, and the bonding interactions between substrate, glaze and cement likewise apply to this embodiment.

For example, the high silica glaze coating 125 is typically applied to the underside of a pressed or extruded tile 110 using any convenient industrial glaze application technique, such as spraying, waterfall, dipping, dry application, or the like. More typically, for manufacturing ease, and for firing in typical roller hearth kilns, the bonding coating 125 is applied to the valleys 130 commonly formed in the tile body 110 underside rather than over the entire surface (i.e., the bonding coating 125 fills the valleys 130 but generally does not cover the ribs 135 that protrude between and define the valleys 130), so as to reduce the tendency of bonding coatings 125 to be deposited on the roller hearth kiln rollers. The glaze bonding coating 125 is then typically fired to a relatively low temperature, such as about 1150 degrees Celsius, to prevent the glaze 125 from substantially melting so as to maintain a degree of surface roughness on the tile body 110 for the promotion of mechanical bonding. By keeping the compositions within the above-specified limits, chemical bonding to the cement paste layer 120 is thus promoted and enhanced.

As discussed above, the composition of the coatings 125 is typically maintained as low in alumina and as high in silica to promote bonding to the cement paste 120. The coating thickness typically does not exceed the thickness of a few particles; coating thicknesses are typically less than about 50 microns.

In operation, a desired contact surface 140 (typically a roughened or rib 135 and valley 130 surface) of the substrate 110 is at least partially coated 145 with a reactive glaze 125. The at least partially coated contact surface 150 is cured 155 to form a substantially rough glazed contact surface 160. Curing 155 is typically accomplished by firing the at least partially coated contact surface 150 at a temperature of below about 250 degrees Celsius for about 1 to about 3 hours. A mortar/cement layer 120 is applied 165 to the to the substantially rough glazed contact surface 160 and is chemically reacted 170 with the same to form an intermediate bond layer 115. The intermediate bond layer 115 both chemically and mechanically bonds the substrate 110 to the mortar/cement layer 120.

As disclosed above, the bond 115 typically contains less than about 0.25 molar equivalents of alumina. Likewise, the reactive glaze 125 is substantially silica and flux, with molar ratio of silica to flux typically at least about 5 to 1, and more typically at least about 9 to 1. The flux is typically calcia, but may be other compositions, such as about 90 percent calcia and about 10 percent R₂O, where R is chosen from the group including lithium, sodium and potassium.

The glaze coating 125 typically has a maximum thickness of about 50 microns, but may be thicker. For example, in some applications, the glaze coating is desired to have a maximum thickness of about 250 microns.

FIGS. 9A- 10 illustrate another embodiment of the present invention, a low temperature or room temperature bonding systems 200 for tile or conventional aggregate substrates 205. In this embodiment, relatively low temperature (typically less than about 250° C. curing temperature) or room temperature (typically from about 20° C. to about 50° C.) coatings 210 are composed of quartz-filled bonding systems 217 such as soluble silicates, siloxanes, or epoxies. These coatings 210 are typically highly loaded with quartz particles 215, typically 35 to 200 microns in size, within a bonding network 220. More typically, the quartz particles are exposed through the bonding coating 210 to promote chemical bonding of the quartz particles 215 to the cement paste 225. The composition of the high-temperature coating, in the previous example, represents the upper limit of potential composition (with the lower limit being pure SiO₂). Typically, a low-viscosity bonding medium 220 with high surface tension is selected, since such a bonding medium 220 promotes the formation of a uniform bonding surface 230 with protruding quartz particles 215. Such bonding media 220 include soluble silicates (such as Na-silicate or NH₄-silicate), siloxanes (such as polymers with silicon in the polymeric chain backbone), and epoxy based systems (composed of the epoxy and a catalyst).

Soluble silicates represent a particularly robust bonding media 220. Na-silicate (commonly referred to as “water glass”) and NH₄-silicate are water soluble silicates that when dried form strong, hard glasses. This medium 220 has three advantages: it is inexpensive, readily available, and provides an additional silicate surface for chemical bonding to the cement paste (as illustrated schematically in FIGS. 9A-9C). It has other advantages such as being water soluble, providing for infinite dilution and thus control of the concentration of the bonding phase. The ammonia silicate (NH₄-silicate) has the additional advantage of not contributing excess sodium, which is not desired in cementitious bonding layers 225. Typically, solutions between 43% and 10% (solids loading of the silicate) are used, but any concentration would be acceptable. The concentration of quartz suspended in that solution typically ranges from 5 to 30 volume percent, more typically from 15-20 percent (volume basis). These coatings 210 may be applied by any conventional methods, such as spray, waterfall, or by dipping to tile and by pan pelletization for the conventional aggregate coating. The coatings 210 are typically then cured, either at room temperature or at temperatures below about 250° C., more typically at about 110° C.

Siloxane-based media 220 allow a silicon based polymeric bonding matrix to extend between the quartz grains 215. These media 220 are not water soluble, however, and thus need to be diluted, such as with alcohol. The quartz particle solid-loading is similar to that described above inreference to soluble silicate media coatings 210. A dilute, low viscosity application suspension is typically selected to promote the exposure of quartz grains 215 through the coating media 220. Room temperature or low temperature curing (less than 250° C.) is typical.

Epoxy based media 220 have the advantage of offering potentially very high bonding strength in the bonding layer 210. However, since epoxies 220 are not water soluble, the cross linking is often difficult if excessively dilute. These media 220 have the advantage of being room temperature cured thus avoiding the need for a higher temperature curing cycle. The application of both the siloxane and epoxy media 220 are accomplished as described above in regards to the soluble silicate media 220.

In operation, the quartz aggregate 215 and bonding medium 220 are mixed to form a bonding system 217. The bonding system 217 is applied to a substrate or aggregate material 205 and then cured 235 to form a bonding layer 210. The substrate is typically ceramic, but may be non-ceramic as well. The bonding system is typically cured by firing to a low curing temperature (typically, less than about 250 degrees Celsius and more typically to a temperature of about 110 degrees Celsius, but may be allowed to cure at room temperature or the like) to form the cured bonding layer 235. A cement or mortar layer 225 is then applied to the cured bonding layer 235. The cement/mortar layer 225 is allowed to react with the cured bonding layer 235, and, more typically, with the protruding quartz particles 215, to form a bond layer 230 around the quartz particles 215.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

We claim:

1. A method for strengthening the bond between an aluminosilicate substrate and a mortar/cement, comprising:
a) at least partially coating a contact surface of an aluminosilicate substrate with a reactive glaze;
b) curing the at least partially coated contact surface to form a substantially rough glazed contact surface;
c) applying a mortar/cement layer to the substantially rough glazed contact surface;
d) chemically reacting the substantially rough glazed contact surface with mortar/cement layer to form an intermediate bond layer;
wherein the intermediate bond layer both chemically and mechanically bonds the substrate to the mortar/cement layer.

2. The method of claim 1 wherein the aluminosilicate substrate has less than about 0.25 molar equivalents of alumina and wherein the mortar/cement is Portland cement.

3. The method of claim 2 wherein the reactive glaze is substantially silica and flux and wherein the molar ratio of silica to flux is at least about 5 to 1.

4. The method of claim 2 wherein the reactive glaze is substantially silica and flux and wherein the molar ratio of silica to flux is at least about 9 to 1.

5. The method of claim 4 wherein the flux is substantially calcia.

6. The method of claim 5 wherein the flux is about 90 percent calcia and about 10 percent R₂O and wherein R is chosen from the group including lithium, sodium and potassium.

7. The method of claim 1 wherein the glaze coating has a maximum thickness of about 50 microns.

8. The method of claim 1 wherein the glaze coating is less than about 250 microns thick.

9. The method of claim 1 wherein the at least partially coated contact surface is cured by heating the at least partially coated contact surface to a temperature of less than about 250 degrees Celsius.

10. A strengthened tile system, comprising:
an aluminosilicate substrate phase;
a cementitious phase; and
a glaze phase bonded between the aluminosilicate substrate phase and the cementitious phase;
wherein the aluminosilicate substrate phase contains less than about 0.25 molar equivalents of alumina and wherein the glaze phase is substantially silica and flux and wherein the molar ratio of silica to flux is at least about 5 to 1.

11. The strengthened tile system of claim 10 wherein the cementitious phase is Portland cement and wherein the molar ratio of silica to flux is at least about 9 to 1.

12. The strengthened tile system of claim 11 wherein the flux further includes calcia and R₂O; wherein the flux is about 90 mole percent calcia and about 10 mole percent R₂O; and wherein R is selected from the group including lithium, sodium and potassium.

13. The strengthened tile system of claim 12 wherein the flux further includes calcia and R₂O; wherein the flux is about 70 mole percent calcia and about 30 mole percent R₂O; and wherein R is selected from the group including lithium, sodium and potassium.

14. A method for increasing the strength of the bond between a substrate and a cementitious layer, comprising:
a) applying a coating of adhesive bonding material to a substrate;
b) curing the bonding material to form a bonding layer;
c) applying a cementitious phase layer at least partially over the bonding layer; and
d) at least partially reacting the cementitious phase layer with the bonding layer to form a bond region.

15. The method of claim 14 wherein the bonding material is a high-silica glaze, further comprising silica and flux; wherein the molar ratio of silica to flux is at least about 5 to 1; wherein the flux further comprises RO and R₂O; wherein the molar ratio of RO to R₂O is at least about 7 to 3; wherein RO is selected from the group including CaO, SrO, BaO, ZnO, FeO, PbO and their combinations; and wherein R₂O is selected from the group including Li₂O, Na₂O, K₂O, and their combinations.

16. The method of claim 14 wherein the bonding material is substantially silica, alumina and flux and wherein the molar ratio of flux to alumina is about 5:1.

17. The method of claim 14 wherein the bonding material further comprises a plurality of aggregate particles in an adhesive matrix and wherein the adhesive matrix is cured at a temperature below about 250 degrees Celsius.

18. The method of claim 17 wherein the adhesive matrix is an epoxy and wherein the adhesive matrix is cured substantially at room temperature.

19. The method of claim 17 wherein the adhesive matrix is a siloxane.

20. The method of claim 17 wherein the adhesive matrix is a water soluble silicate.

21. The method of claim 20 wherein the water soluble silicate is chosen from the group consisting of sodium silicate and ammonium silicate and wherein the aggregate particles are quartz particles ranging from between about 35 to about 200 microns in diameter.

22. A high-strength bonded tile system, comprising:
a densified aluminosilicate tile member;
a cementitious matrix phase; and
a high-silica glaze phase bonded between the densified aluminosilicate tile member and the cementitious matrix phase;
wherein the densified aluminosilicate tile member contains less than about 0.25 molar equivalents of alumina;
wherein the high-silica glaze phase further comprises silica and flux;
wherein the molar ratio of silica to flux is at least about 5 to 1;
wherein the flux further comprises RO and R₂O;
wherein the molar ratio of RO to R₂O is at least about 7 to 3;
wherein RO is selected from the group including CaO, SrO, BaO, ZnO, FeO, PbO and their combinations; and
wherein R₂O is selected from the group including Li₂O, Na₂O, K₂O, and their combinations.

23. A method of producing a high-strength cement-porcelain tile bond, comprising:
a) identifying a first porcelain tile surface and a cementitious second surface to be bonded together;
b) treating the first porcelain tile surface by glazing a bonding layer thereto;
c) preparing the first porcelain tile surface for bonding by firing the first porcelain surface to a temperature of at least about 1150 degrees Celsius; and
d) joining the prepared first porcelain surface and the cementitious second surface chemically in the bonding layer;
wherein the bonding layer is a glaze having the general formula of (0.1 R₂O, 0.9 RO)·6.0 SiO₂;
wherein R₂O is selected from the group consisting of Li₂O, Na₂O, K₂O, and their combinations; and
wherein RO is selected from the group consisting of CaO, SrO, BaO, ZnO, FeO, PbO and their combinations.
